(19) United States
(12) Patent Application Publication
(10) Pub. No.: US 2002/0097556 A1
(43) Pub. Date: Jul. 25, 2002

(54) Shockproof device of a hard disk drive

(76) Inventor: Jui-Ju Lee, Taipei Hsien (TW)

Correspondence Address: BACON & THOMAS, 625 Slaters Lane - 4th Floor, Alexandria, VA, 22314, US

(21) Appl. No.: 09/768,346

(22) Filed: Jan. 25, 2001

(51) Int. Cl. G06F 1/16; G11B 33/02; F16M 3/00

(52) U.S. Cl. 361/685; 248/633; 248/634; 248/636; 248/638; 248/618; 369/75.1; 369/75.2; 369/76; 369/77.1; 369/77.2; 369/78; 369/79; 369/80; 369/81; 369/82

(57) ABSTRACT

The present invention relates to a shockproof device of a hard disk drive in which a plurality of springs are mounted on slide rail seats at sides of hard disk drive of notebook computer in order that the hard disk drive is disposed in a hanging arrangement. Besides, the inner five sides (except the hard disk drive extraction side) of the hard disk drive housing are provided with shock-absorbing blocks for improving the shockproof function. In addition, two sides of the hard disk drive housing are fitted with the slide rail seats for the convenient extraction of the hard disk drive. Accordingly, a better shockproof effect is achieved.

### BACKGROUND OF THE INVENTION

1. Field of the Invention

The present invention relates to a shockproof device of a hard disk drive, and more particularly, to a shockproof device which is mounted on slide rail seats of a hard disk drive of a notebook computer while the slide rail seats include a plurality of springs for improving the shockproof function. In addition, two sides of the hard disk drive housing are fitted with the slide rail seats for the convenient extraction of the hard disk drive. Accordingly, a better shockproof effect is achieved.

2. Description of the Prior Art

A conventional shockproof device of a hard disk drive, as shown in FIG. 1, includes a plurality of resilient pieces 101, a shock-absorbing sponge 102 and a base 100. The base 100 is fixed on the housing of a notebook computer and fitted with a plurality of resilient pieces 101. The resilient pieces 101 include a threaded hole 104, respectively. The hard disk drive 300 is fixed on the base 100 by means that screws 103 are fastened from the bottom of the base 100 inwards. The shock-absorbing sponge 102 is disposed at center of the base 100. The configuration that such a shock-absorbing device is used to absorb the external shock includes drawbacks. The hard disk drive 300 only has resilient pieces 101 and a shock-absorbing sponge 102 at bottom thereof Moreover, no other shockproof devices are mounted on other sides of the hard disk drive 300, thereby causing damages to the magnetic tracks of the hard disk drive 300 due to shock and vibration in all directions in use, particularly for the hard disk drive fitted to the car.

### SUMMARY OF THE INVENTION

It is a primary object of the present invention to eliminate the aforementioned drawbacks and to provide a shockproof device of a hard disk drive in which a plurality of springs are mounted on slide rail seats of hard disk drive in order that the hard disk drive is disposed in a hanging arrangement. Besides, the inner five sides (except the hard disk drive extraction side) of the hard disk drive housing are provided with shock-absorbing blocks for improving the shockproof function. Accordingly, a better shockproof effect is achieved.

### BRIEF DESCRIPTION OF THE DRAWINGS

The drawings disclose illustrative an embodiment of the present invention which serves to exemplify the various advantages and objects hereof, and are as follows:

FIG. 1 is a perspective exploded view of a conventional shockproof device of a bard disk drive;

FIG. 2 is a perspective assembly view of a preferred embodiment of the present invention;

FIG. 3 is a perspective exploded view of the preferred embodiment of the present invention;

FIG. 4 is a sectional view taken along A-A of FIG. 3; and

FIG. 5 is a sectional view taken along B-B of FIG. 3.

### DETAILED DESCRIPTION OF THE PREFERRED EMBODIMENT

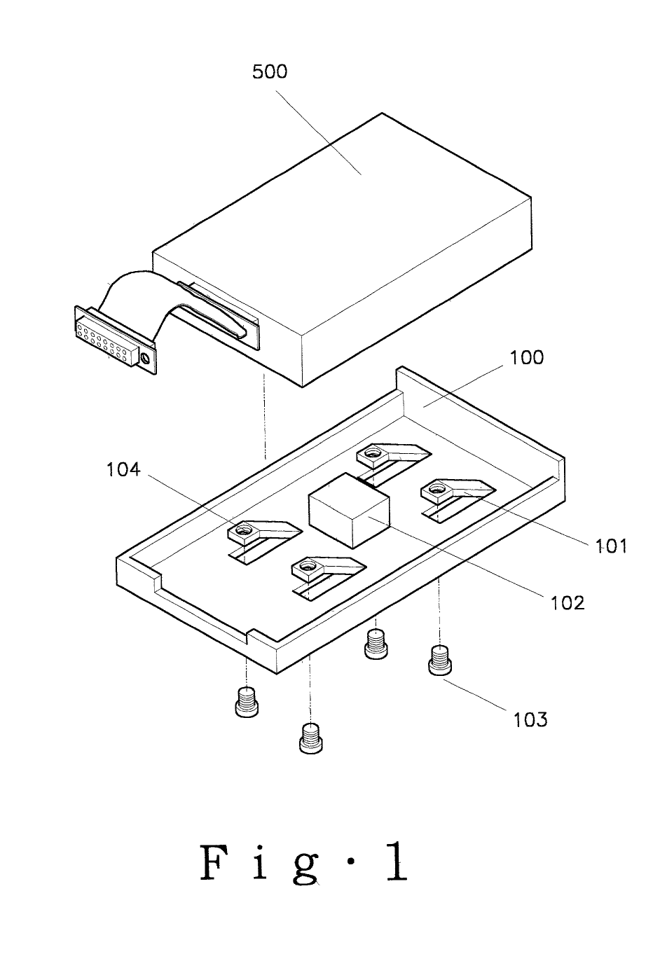

FIG. 1 shows a perspective assembly view of a conventional ceiling loudspeaker. The configuration and the disadvantage thereof have been shown above and won't be described more hereinafter.

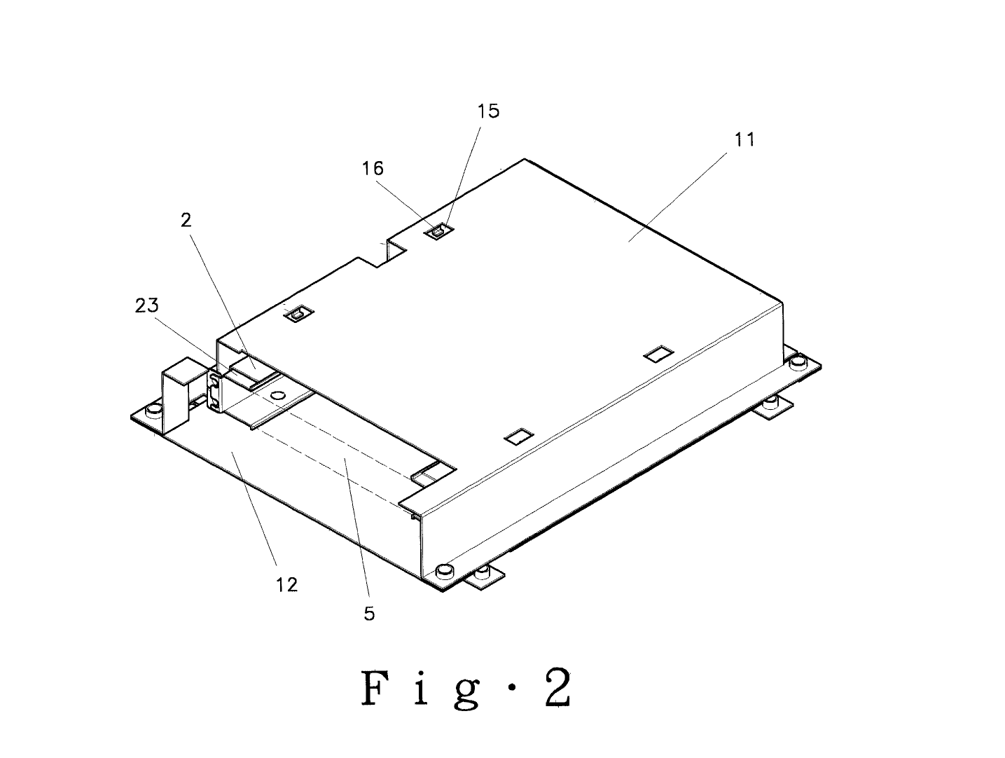

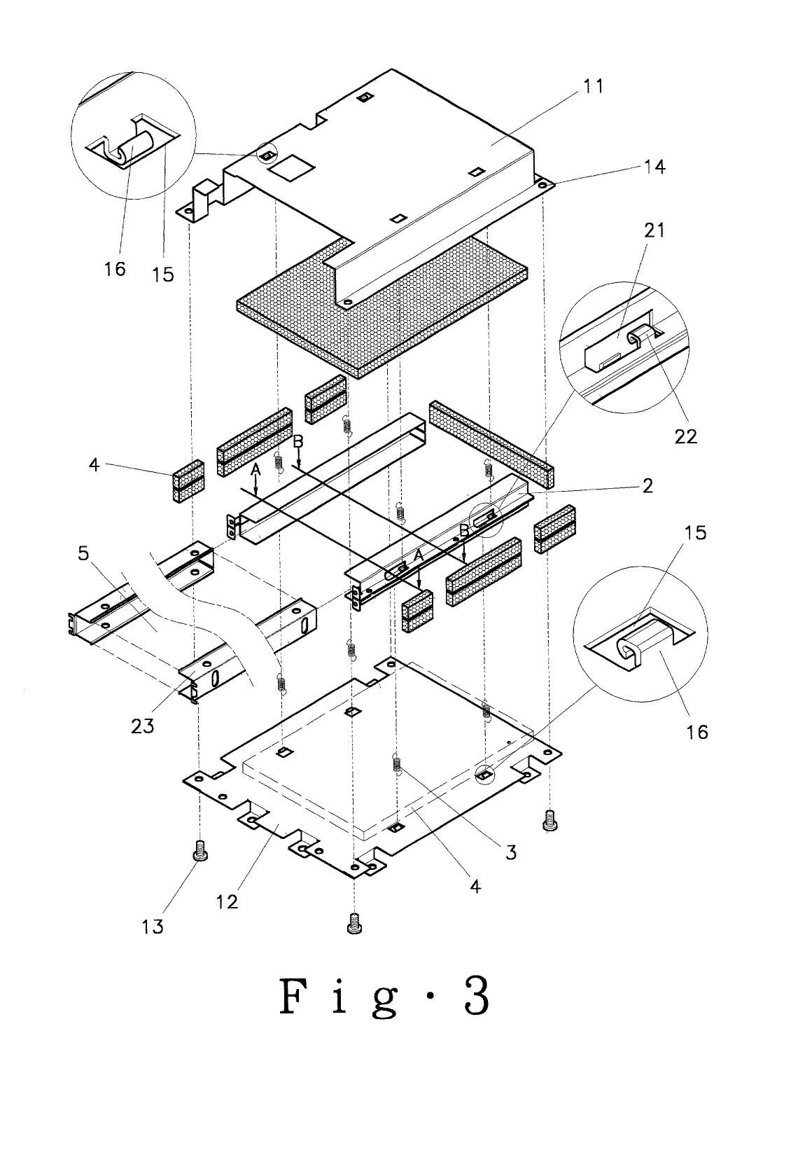

Referring to FIGS. 2 and 3, the shockproof device of a hard disk drive in accordance with the present invention at least includes a hard disk drive housing 1, a plurality of slide rails 2, a plurality of springs 3 and a plurality of shock-absorbing blocks 4. The hard disk drive housing 1 is composed of a top cover 11 and a bottom plate 12 both of which include a plurality of housing hook grooves 15 with housing projecting hooks 16 therein. The slide rail seat 2 consists of two identical metal sheets while the slide rail seats 2 include a plurality of rail hook grooves 21 with rail projecting hooks 22 therein at the corresponding position to the housing hook grooves 15.

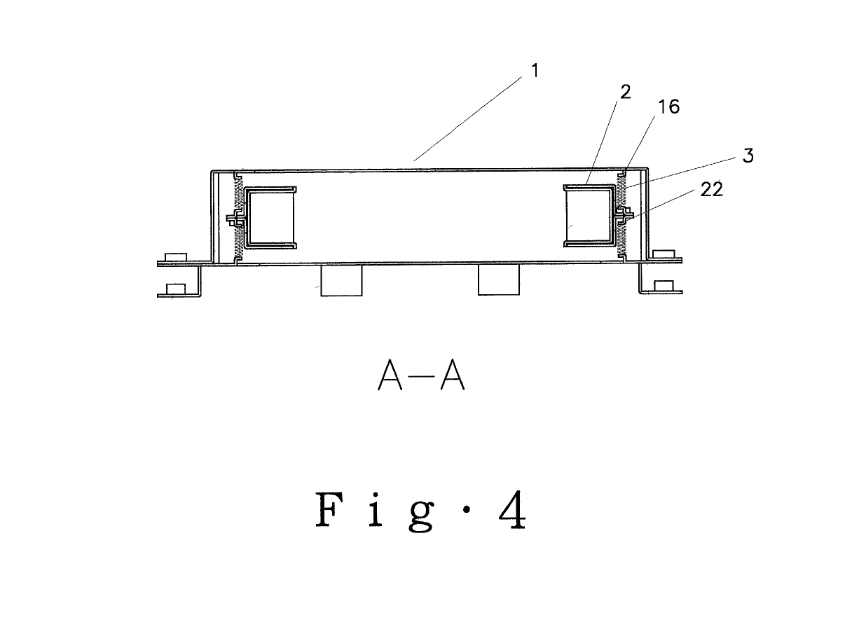

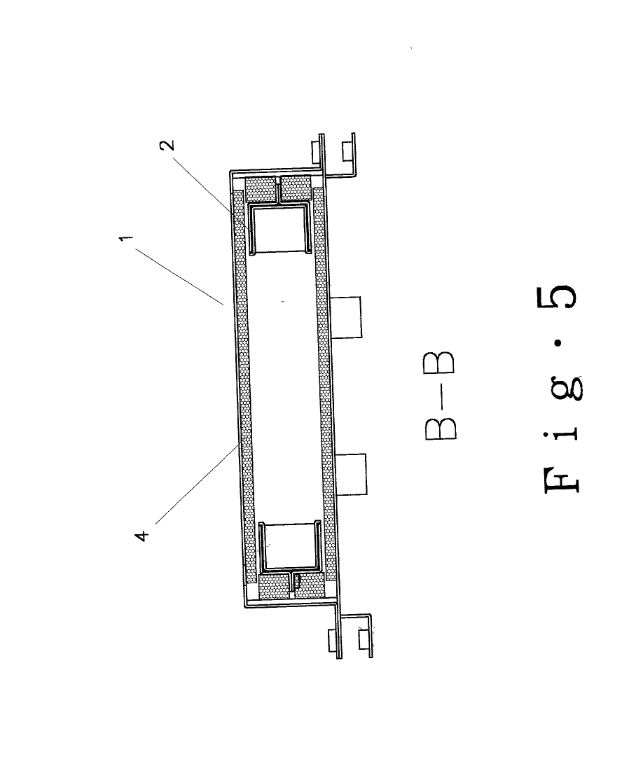

In assembly, referring to FIG. 4, the springs 3 are respectively hooked on the housing projecting hooks 16 of the hard disk drive housing 1 and the rail projecting hooks 22 of the slide rails 2, thereby hanging the slide rails 2 on the hard disk drive housing 1. Besides, the shock-absorbing blocks 4 are interposed between the hard disk drive housing 1 and the slide rails 2, and, to be precise, at five inner sides of the hard disk drive housing 1 except the hard disk drive extraction side (see FIG. 5), that is, only storing and cooling space of hard disk drive 5 are reserved. Thereafter, a plurality of screws 13 penetrate through screw holes 14 of the bottom plate 12 and are fastened on the top cover 11. In addition, slide rails 23 are fastened at two sides of the hard disk drive 5. In use, as shown in FIG. 2, the slide rails 23 at two sides of the hard disk drive 5 are attached to the slide rail seat 2 of the hard disk drive housing 1 while the hard disk drive 5 is inserted into the hard disk drive housing 1. By means of the arrangement of the springs 3 and the shock-absorbing blocks 4, the hard disk drive 5 can be protected from damage caused by unexpected vibration and shock in all directions during movement or transportation.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A shockproof device of a hard disk drive at least comprising a hard disk drive housing, a plurality of slide rail seats with slide rails, a plurality of springs and a plurality of shock-absorbing blocks;
wherein said springs and said slide rail seats are hooked and hung in said hard disk drive housing while the shock-absorbing blocks are interposed between said hard disk drive housing and said slide rail seats, and only storing and cooling space of the hard disk drive is reserved, and wherein said slide rails are fastened at sides of said hard disk drive while said hard disk drive slides into said slide rail seats by means of said slide rails, and said hard disk drive is engaged in said hard disk drive housing for reaching the shockproof effect.

2. A shockproof device of a hard disk drive as claimed in claim 1, wherein said shock-absorbing blocks are disposed at five inner sides of the hard disk drive housing except the hard disk drive extraction side.

3. A shockproof device of a hard disk drive as claimed in claim 1 or 2, wherein said shock-absorbing blocks 4 are made of shock-absorbing sponge with high density.

4. A shockproof device of a hard disk drive as claimed in claim 1 or 2, wherein said hard disk drive housing includes a top cover and a bottom plate both of which are screwed together.

5. A shockproof device of a hard disk drive as claimed in claim 1 or 2, wherein said hard disk drive housing includes a plurality of projecting hooks while said slide rail seats also include a plurality of projecting hooks at corresponding positions to said projecting hooks of said hard disk drive housing, and wherein said springs are respectively hooked on said projecting hooks of said hard disk drive housing and said slide rail seats, and wherein an alternative way to hook said slide rails lies in that said slide rail seats are hung on said hard disk drive housing.
